(19) United States
(12) Patent Application Publication
(10) Pub. No.: US 2024/0311084 A1
(43) Pub. Date: Sep. 19, 2024

(54) NEAR-MEMORY PSEUDORANDOM NUMBER GENERATION

(71) Applicant: Micron Technology, Inc., Boise, ID (US)

(72) Inventors: David Andrew Roberts, Wellesley, MA (US); Tony M. Brewer, Plano, TX (US); Scott Lynn Michaelis, Plano, TX (US)

(21) Appl. No.: 18/606,809

(22) Filed: Mar. 15, 2024

Related U.S. Application Data
(60) Provisional application No. 63/452,588, filed on Mar. 16, 2023.

(51) Int. Cl. G06F 7/58

(52) U.S. Cl. CPC G06F 7/582

(57) ABSTRACT

Various examples are directed to systems and methods for generating a set of pseudorandom numbers in a computing system comprising a compute element and a memory device. A memory controller of the memory device may receive, from the compute element, an indication to generate a set of pseudorandom numbers. The memory controller may generate the set of pseudorandom numbers and write the set of pseudorandom numbers to a memory array of the memory device for access by the compute element.

### PRIORITY APPLICATION

This application claims the benefit of priority to U.S. Provisional Application Ser. No. 63/452,588, filed Mar. 16, 2023, which is incorporated herein by reference in its entirety.

### BACKGROUND

Various computer architectures, such as the Von Neumann architecture, conventionally use a shared memory for data, a bus for accessing the shared memory, an arithmetic unit, and a program control unit. However, moving data between processors and memory can require significant time and energy, which in turn can constrain performance and capacity of computer systems. In view of these limitations, new computing architectures and devices are desired to advance computing performance beyond the practice of transistor scaling (i.e., Moore's Law).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagram showing one example of a compute-near-memory (CNM) system that may be used to perform near-memory pseudorandom number generation as described herein.

FIG. 2 is a flowchart showing one example of a process flow that may be executed in a CNM system to generate a set of pseudorandom numbers.

FIG. 3 is a flowchart showing one example of a process flow that may be executed by a compute element and a memory device to generate a set of pseudorandom numbers.

FIG. 4 is a flowchart showing one example of a process flow that may be executed by a memory controller to generate a set of pseudorandom numbers.

FIG. 5 is a flowchart showing one example of a process flow that may be executed by a memory controller to write a set of pseudorandom numbers to an associated memory array.

FIG. 6 is a flowchart showing another example of a process flow that may be executed by a memory controller to write a set of pseudorandom numbers to an associated memory array.

FIG. 7 is a diagram showing an example CNM system that may be used to practice the example systems and methods described herein.

FIG. 8A illustrates generally an example of a chiplet system, according to an embodiment.

FIG. 8B illustrates generally a block diagram showing various components in the chiplet system from the example of FIG. 8A.

FIG. 9 illustrates generally an example of a chiplet-based implementation for a memory-compute device, according to an embodiment.

FIG. 10 illustrates a block diagram of an example machine with which, in which, or by which any one or more of the techniques (e.g., methodologies) discussed herein can be implemented.

### DETAILED DESCRIPTION

Various different kinds of computing operations utilize random number sets. Examples of such operations include various cryptographic operations, creating test signals, transmitting and/or receiving spread spectrum signals, certain computer modeling applications (e.g., Monte Carlo simulations) and/or the like.

Computing systems may generate pseudorandom number sets for use in these and other operations. A pseudorandom number set is a set of numbers generated according to a deterministic process to conform to one or more statistical tests for randomness. Because the pseudorandom number set is generated deterministically, it may not be truly random, but may still be suitable for various different types of computing operations.

Generating sets of pseudorandom numbers for computing operations can be a compute and memory bandwidth-intensive process. For example, a host processor may be programmed to apply a deterministic process to generate a set of pseudorandom numbers and then write the set of pseudorandom numbers to a memory device. The pseudorandom numbers may be accessed from the memory device as needed. This may occupy computing resources at the host processor, bus resources between the host processor and the memory device, as well as memory read and write resources. Further, using the host processor, various busses, and the memory device to generate pseudorandom number sets may divert those resources from performing operations related to higher-level applications.

In some examples described herein, sets of pseudorandom numbers may be generated in a compute-near-memory (CNM) arrangement. A CNM arrangement is an example memory-centric compute topology that includes or uses memory devices that are associated with processors, or processing capabilities, provided in, near, or integrated with memory devices.

In various examples, a CNM system may comprise one or more host processors and one or more memory devices, with the memory devices comprising processors or processing capabilities, as described herein. For example, a memory device may comprise a memory controller including pseudorandom number generation (PRNG) logic and, optionally, a data mover. The memory device may comprise a memory array including a plurality of memory locations and/or may be in communication with an external memory array outside of the memory device.

The memory controller (e.g., the PRNG logic circuit thereof) may be configured to generate a set of pseudorandom numbers in response to an indication from the host processor. The memory controller may generate the set of pseudorandom numbers in any suitable manner according to any suitable deterministic process, for example, as described herein. The memory controller may write the set of pseudorandom numbers to the memory array. The host processor may access the set of pseudorandom numbers directly from the memory array. In this way, the host processor may obtain a set of pseudorandom numbers without utilizing host processor resources to generate the set of pseudorandom numbers. Also, because the set of pseudorandom numbers are produced by a memory controller near the memory array, usage of bus resources for moving the set of pseudorandom numbers to the memory array may be reduced.

In some examples, the memory controller (e.g., the data mover thereof) may scatter the set of pseudorandom numbers to a predetermined set of locations at the memory array. The predetermined set of locations may be indicated in any suitable manner such as, for example, by a set of address pointers, by a start address and an offset or stride, and/or the like. In some examples, this further improves the efficiency of the CNM system. For example, the set of pseudorandom numbers may be written to the memory array at locations that are logically adjacent to the locations of other data used by the host processor in its processing. In this way, the host processor may be able to make a single read to the memory device to retrieve a pseudorandom number from the set of pseudorandom numbers and other input data, e.g., for use with the pseudorandom number.

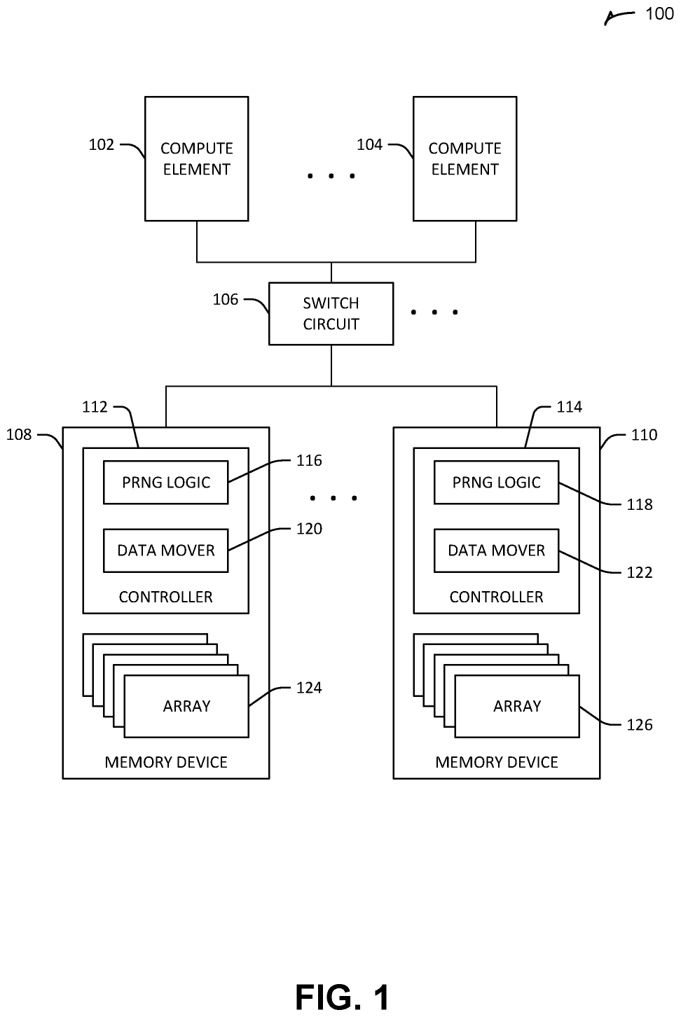

FIG. 1 is a diagram showing one example of a CNM system 100 that may be used to perform near-memory pseudorandom number generation as described herein. The CNM system 100 comprises compute elements 102, 104 and memory devices 108, 110.

The compute elements 102, 104 may be any suitable processor or similar element in a CNM system. For example, the compute elements 102, 104 may be or include host processors, accelerators, graphics processing units (general-purpose computing on graphics processor units or GPGPU devices), and/or the like. Although two compute elements 102, 104 are shown in FIG. 1, it will be appreciated that various example CNM systems may comprise more or fewer host processors than are shown. Also, although two memory devices 108, 110 are shown in FIG. 1, it will be appreciated that various example CNM systems may comprise more or fewer memory devices than are shown.

In the example of FIG. 1, the compute elements 102, 104 and memory devices 108, 110 are in communication with one another via a switch circuit 106. The switch circuit 106 can be configured to couple various endpoints, such as, for example, various compute elements 102, 104 and various memory devices 108, 110. The switch circuit 106 can be arranged according to various suitable formats and configurations. In some examples, the switch 106 may be omitted and the compute elements 102, 104 may communicate directly with the respective memory devices 108, 110.

In some examples, the switch circuit 106 utilizes a specialized or other communication protocol, generally referred to herein as a chip-to-chip protocol interface (CTCPI). That is, the CTCPI can include a specialized interface that is unique to the CNM system 100, or can include or use other interfaces such as the compute express link (CXL) interface, the peripheral component interconnect express (PCIe) interface, the chiplet protocol interface (CPI), an interface using an Advanced extensible Interface (AXI) protocol, such as AXI4 and/or the like. For example, the switch circuit 106 can include a switch configured to use the CTCPI. For example, the switch circuit 106 can include a CXL switch, a PCIe switch, a CPI switch, or other type of switch. In an example, the switch circuit 106 can be configured to couple differently configured endpoints. For example, the switch circuit 106 can be configured to convert packet formats, such as between PCIe and CPI formats and/or between AXI and CXL formats, among others.

Memory devices 108, 110 may comprise respective memory controllers 112, 114 and memory arrays 124, 126. Memory arrays 124, 126 may comprise respective pluralities of locations where data units may be written and read. Examples of data that may be written to a location at the respective memory arrays 124, 126 include pseudorandom numbers from a set of pseudorandom numbers. Various memory locations at the respective memory arrays 124, 126 may also store other data such as, for example, input data to be used by the compute elements 102, 104 and/or memory controllers 112, 114, output data generated by the compute elements 102, 104 and/or memory controllers 112, 114, and/or the like.

The memory arrays 124, 126 may be, or include any combination of, volatile or non-volatile memories. Examples of volatile memory devices include, but are not limited to, random access memory (RAM)—such as DRAM) synchronous DRAM (SDRAM), graphics double data rate type 6 SDRAM (GDDR6 SDRAM), among others. Examples of non-volatile memory devices include, but are not limited to, negative-and-(NAND)-type flash memory, storage class memory (e.g., phase-change memory or memristor based technologies), ferroelectric RAM (FeRAM), among others.

The respective memory controllers 112, 114, in some examples, may be arranged to generate pseudorandom numbers as described herein. For example, the respective memory controllers 112, 114 may comprise PRNG logic circuits 116, 118 and respective data mover circuits 120, 122. The PRNG logic circuits 116, 118 may comprise various processors, graphical processing units (GPUs), application-specific integrated circuits (ASICs), and/or the like configured to generate sets of pseudorandom numbers.

The data mover circuits 120, 122 may comprise any suitable hardware for writing pseudorandom numbers to the respective arrays 124, 126. In some examples, the data mover circuits 120, 122 may be arranged to implement a scatter/gather arrangement that writes pseudorandom numbers to the memory arrays 124, 126 at non-contiguous locations, for example, as described herein.

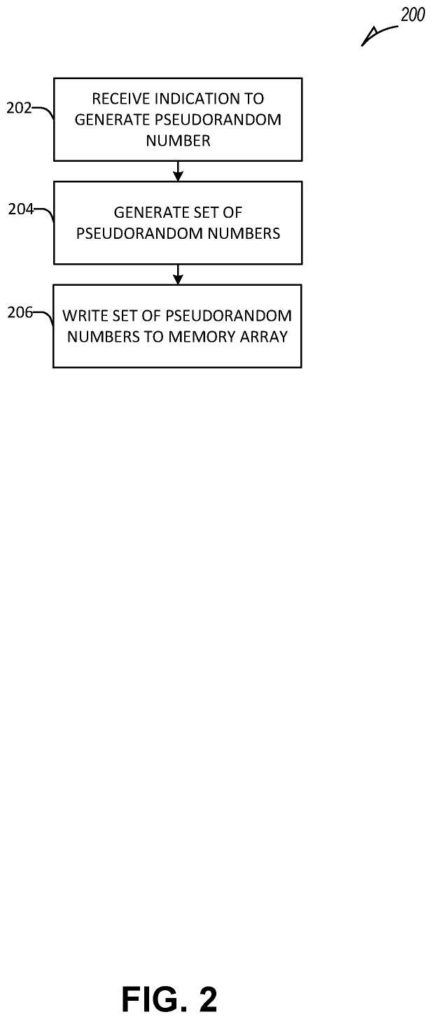

FIG. 2 is a flowchart showing one example of a process flow 200 that may be executed in the CNM system 100 to generate a set of pseudorandom numbers. The process flow 200 is described with respect to the compute element 102 and the memory device 108. It will be appreciated, however, that the process flow 200 may be executed with respect to any suitable combination of a compute element 102, 104 and a memory device 108, 110.

At operation 202, the memory controller 112 of the memory device 108 may receive an indication to generate a set of pseudorandom numbers. The indication may be received in various different forms. In some examples, the indication comprises a request to generate the pseudorandom number set received from the compute element 102. Also, in some examples, the indication may be a read request received from the compute element 102. The read request may indicate that the set of pseudorandom numbers is to be generated, for example, by including data indicating a location at the memory array 124 that the memory controller 112 is programmed to associate with the generation of a set of pseudorandom numbers.

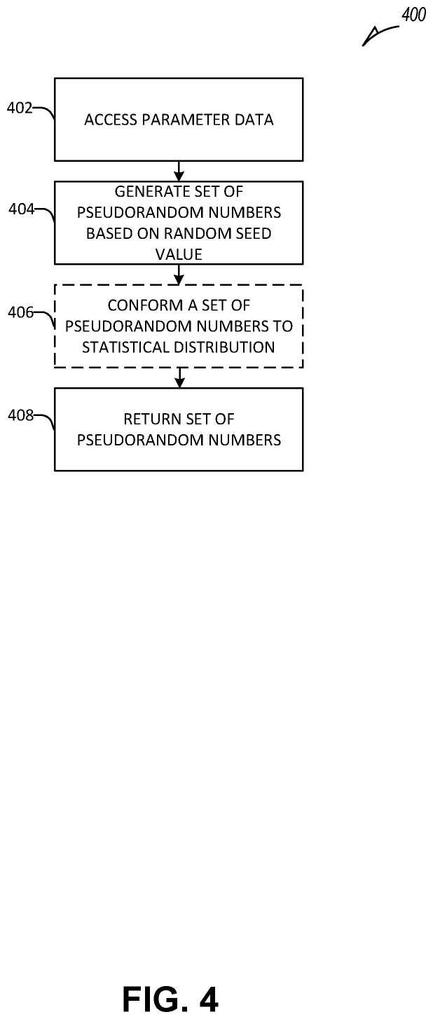

At operation 204, the memory controller 112 (e.g., the PRNG logic is circuit 116 thereof) may generate a set of pseudorandom numbers in response to the indication received at operation 202. The set of pseudorandom numbers may be generated using any suitable deterministic process, such as, for example MRG8. The generating of the set of pseudorandom numbers may be based on parameter data describing one or more parameters for generating the set of pseudorandom numbers. Example parameters include a precision value, a random seed, and a statistical distribution to which the set of pseudorandom numbers may be conformed. Further details describing how the memory controller 112 may generate a set of pseudorandom numbers are provided herein, for example, with respect to FIG. 4.

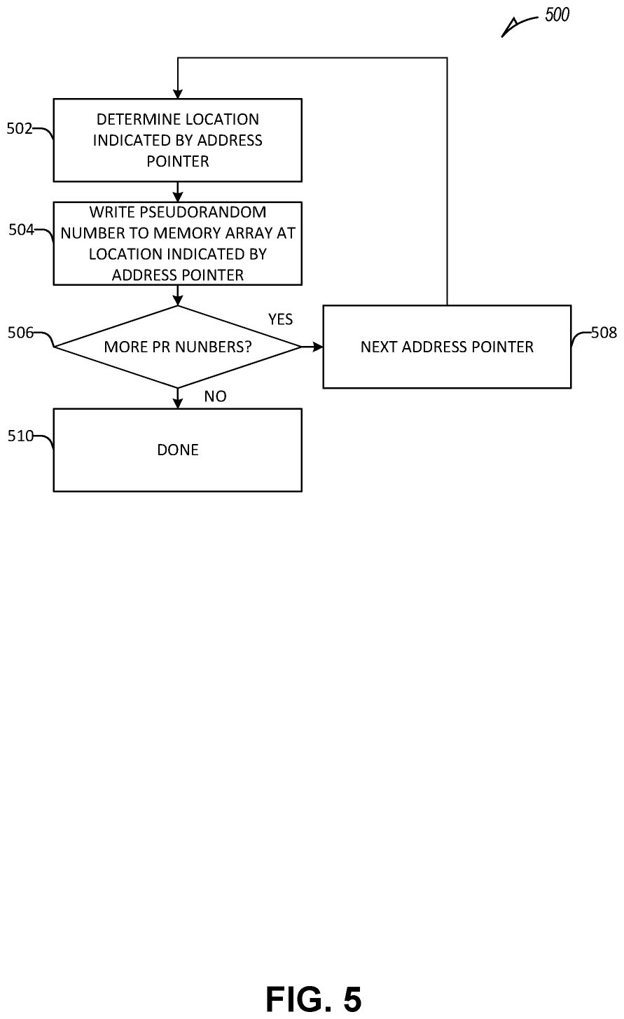

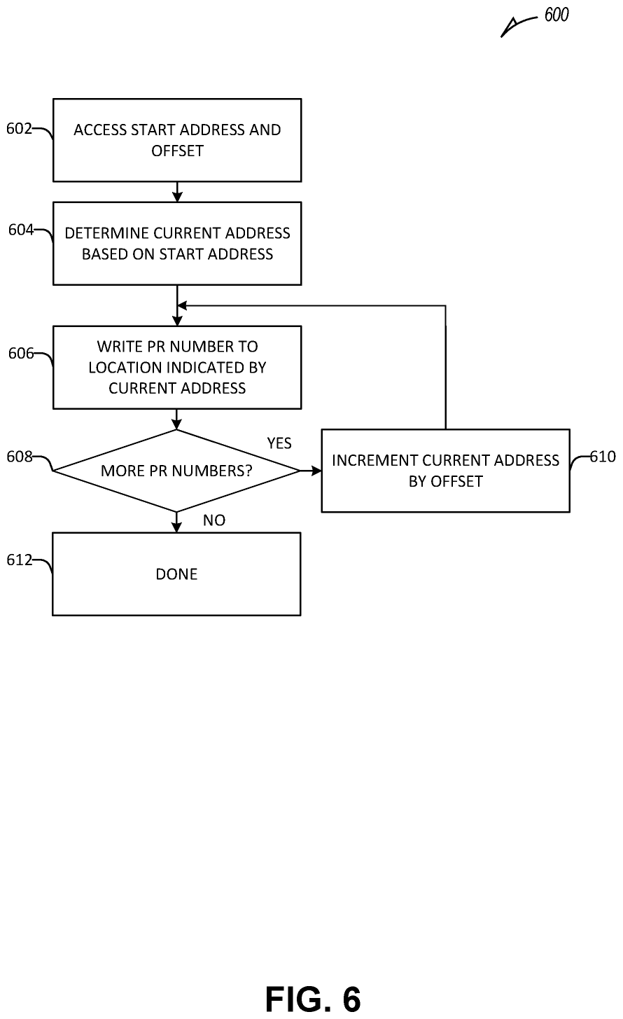

At operation 206, the memory controller 112 (e.g., the data mover circuit 120 thereof) writes the set of pseudorandom number values to the memory array 124. For example, the memory controller 112 may write the set of pseudorandom number values to the memory array 124 based on storage configuration data, which may be received from the compute element 102. In some examples, the storage configuration data comprises a set of address pointers referencing addresses of one or more locations at the memory array 124. The data mover circuit 120 may write the set of pseudorandom numbers to the locations at the memory array 124 associated with the set of address pointers. In some examples, the storage configuration data comprises a start address referring to a start location at the memory array 124 and a stride or offset, which may be an integer. The data mover circuit 120 may write a first pseudorandom number from the set of pseudorandom numbers to the start location at the memory array 124. The data mover circuit 120 may write a second pseudorandom number from the set of pseudorandom numbers to a second location at the memory array 124 that is determined based on the start location and the offset. The data mover circuit may write ⅓ pseudorandom numbers from the set of pseudorandom numbers to ⅓ location at the memory array 124 that is determined based on the second location and the offset, and so on. Additional details describing how the data mover circuit 120 may write the set of pseudorandom numbers to the memory array 124 are described herein with respect to FIGS. 5 and 6.

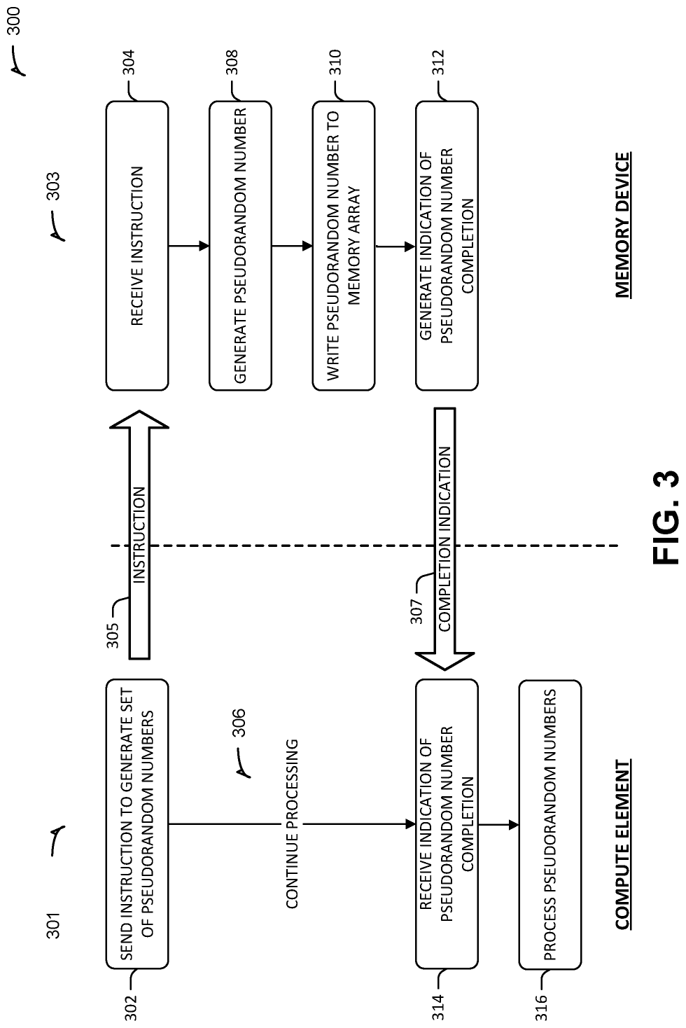

FIG. 3 is a flowchart showing one example of a process flow 300 that may be executed by a compute element and a memory device to generate a set of pseudorandom numbers. The process flow 300 comprises two columns 301, 303. The column 301 includes operations that may be executed by a compute element, such as one of the compute elements 102, 104 shown in FIG. 1. The column 303 includes operations that may be executed by a memory device, such as one of the memory devices 108, 110 shown in FIG. 1.

At operation 302, the compute element may send an instruction 305 to the memory device. The instruction 305 comprises an indication that the memory device is to generate a set of pseudorandom numbers. In some examples, the instruction 305 is a read request comprising addresses for one or more locations at a memory array associated with the memory device. The memory device may be programmed to recognize the read request to the one or more locations as an instruction to generate the set of pseudorandom numbers.

The instruction 305 may comprise various data used by the memory device to generate the set of pseudorandom numbers. For example, the instruction 305 may comprise parameter data that may be used by a PRNG logic circuit of the memory device to generate the set of pseudorandom numbers. The instruction 305 may also comprise storage configuration data that may be used by a data mover circuit of the memory device describing how the data mover circuit will write the set of pseudorandom numbers to the memory array associated with the memory device. The memory device (e.g., a memory controller thereof) may receive the instruction 305 at operation 304.

At operation 308, the memory device (e.g., a PRNG logic circuit thereof) may generate the indicated set of pseudorandom numbers, for example, as described herein. At operation 310, the memory device (e.g., a data mover circuit 120 thereof) may write the set of pseudorandom numbers to the memory array associated with the memory device, for example, as described herein.

At operation 312, the memory device may generate a completion indication 307 indicating that the set of pseudorandom numbers has been generated and written to the memory array. The completion indication 307 may be provided to the compute element. In some examples, the memory device provides the completion indication 307 directly to the compute element, for example, via a switch circuit, one or more buses, or other suitable communication medium. Also, in some examples the completion indication 307 is a flag value stored at a location that is accessible to the compute element.

After sending the instruction 305 to generate the set of pseudorandom numbers, the compute element may, at operation 306, continue its processing while the memory device generates the set of pseudorandom numbers, as described herein. In some examples, this may include the compute element performing operations that do not rely on the set of pseudorandom numbers being generated by the memory device. At operation 314, the compute element receives the completion indication 307. In some examples, receiving the completion indication 307 comprises receiving a message sent by the memory device. In other examples, receiving the completion indication 307 may comprise polling a flag value at a location accessible to the compute element. The compute element may periodically poll the location, for example, until a flag value written at the location indicates that the set of pseudorandom numbers is complete and written to the memory array.

At operation 316, the compute element processes the set of pseudorandom numbers. This may include performing a processing operation that utilizes the set of pseudorandom numbers such as, for example, executing one or more cryptographic operations, creating one or more test signals, transmitting and/or receiving spread spectrum signals, executing a computer model, and/or the like. The compute element may access the set of pseudorandom numbers in any suitable manner. For example, the compute element may request to read the pseudorandom numbers one number at a time on an as-needed basis. In another example, the compute element may send a single request to the memory device that returns the set of pseudorandom numbers in, for example, any batch format.

In some examples, as described herein, the set of pseudorandom numbers may be stored at the memory array in a package with other data that is to be utilized by the compute element in performing its processing operation. The compute element may request one or more of the packages, where each package includes one or more pseudorandom numbers of the set of pseudorandom numbers as well as additional data used for processing the one or more pseudorandom numbers.

FIG. 4 is a flowchart showing one example of a process flow 400 that may be executed by a memory controller, and/or a PRNG logic circuit thereof, to generate a set of pseudorandom numbers. For example, the process flow 400 shows one example of how the memory controller may execute operation 204 of the process flow 200 and/or operation 308 of the process flow 300.

At operation 402, the memory controller may access parameter data describing the set of pseudorandom numbers to be generated. Parameter data may comprise a precision value, a random seed, and/or a statistical distribution. The precision value describes a level of precision for the pseudorandom numbers. For example, the precision value may describe a data type to be used for storing each of the pseudorandom numbers, such as integer, double, float, and/or the like.

The random seed may be a number, vector, or similar quantity that is used as an input to the deterministic process used to generate the set of pseudorandom numbers. The statistical distribution describes a distribution to which the set of pseudorandom numbers is to conform. In some examples, the statistical distribution may be omitted.

At operation 404, the memory controller generates a set of pseudorandom numbers using the random seed. The memory controller may generate the set of pseudorandom numbers using any suitable algorithm or technique such as, for example, MRG8 or a similar algorithm.

At optional operation 406, the memory controller conforms the set of pseudorandom numbers to a statistical distribution. For example, the set of pseudorandom numbers generated at operation 404 may be arranged according to a uniform random distribution. For some operations, however, it may be desirable to have a set of pseudorandom numbers that conform to a different distribution such as an exponential distribution. An example exponential distribution is given by Equation [1] below:

$${x}_{o} = {F}_{x}^{- 1} ( {y}_{o} ) = - \frac{1}{λ} ln ( 1 - {y}_{o} ) \qquad [ 1 ]$$

In the example of Equation [1], the value yₒ is a uniform random number between 0 and 1. The memory controller may conform the set of pseudorandom numbers to the statistical distribution using any suitable technique such as, for example, inverse transform sampling. At operation 408, the memory controller may return the generated set of pseudorandom numbers. For example, the set of pseudorandom numbers may be provided to the data mover circuit, which may write the set of pseudorandom numbers to the memory array.

FIG. 5 is a flowchart showing one example of a process flow 500 that may be executed by a memory controller (e.g., a data mover circuit thereof), to write a set of pseudorandom numbers to an associated memory array. The process flow 500 shows one example way that the memory controller can perform operation 206 of the process flow 200 and/or operation 310 of the process flow 300. The process flow 500 shows an arrangement in which storage configuration data comprises a set of address pointers. In some examples the number of address pointers in the set of address pointers may be equal to or greater than the number of pseudorandom numbers in the generated set of pseudorandom numbers. Each address pointer indicates an address of a location at the memory array.

At operation 502, the memory controller determines a location at the memory array indicated by an address pointer. Initially, the memory controller may determine a location at the memory array indicated by a first address pointer of the set of address pointers. For example, an address denoting the location may be referenced by the address pointer.

At operation 504, the memory controller may write a pseudorandom number of the set of pseudorandom numbers to the memory array at the location indicated by the address pointer determined at operation 502. At operation 506, the memory controller may determine if there are any other pseudorandom numbers from the set of pseudorandom numbers that have yet to be written to the memory array. If there are additional pseudorandom numbers, the memory controller may, at operation 508, access a next address pointer from the set of address pointers and return to operation 502 to determine the location at the memory array indicated by the next address pointer. When there are no additional pseudorandom numbers to be written to the memory array at operation 506, the process may conclude at operation 510.

FIG. 6 is a flowchart showing another example of a process flow 600 that may be executed by a memory controller (e.g., a data mover circuit thereof), to write a set of pseudorandom numbers to an associated memory array. The process flow 600 shows an arrangement in which storage configuration data comprises a start address and a stride or offset.

At operation 602, the memory controller may access the start address and offset. For example, the start address and offset may be part of storage configuration data that is received from the host processor. At operation 604, the memory controller may determine a current address based on the start address. The current address may refer to a location at the memory array. In some examples, the current address is the start address, initially. In other examples, the first current address is determined from the start address.

At operation 606, the memory controller may write a first pseudorandom number from the set of pseudorandom numbers to the location at the memory array indicated by the current address. At operation 608, the memory controller may determine if there are any additional pseudorandom numbers from the set of pseudorandom numbers that have not yet been written to the memory array. If there are additional pseudorandom numbers not yet written to the array, the memory controller may, at operation 610, increment the current address by the offset value. The result may be a new current address. The memory controller may proceed to operation 606 to write the next pseudorandom number from the set of pseudorandom numbers to the location at the memory array indicated by the new current address. When there are no more pseudorandom numbers to be written to the memory array, the process flow may conclude at operation 612.

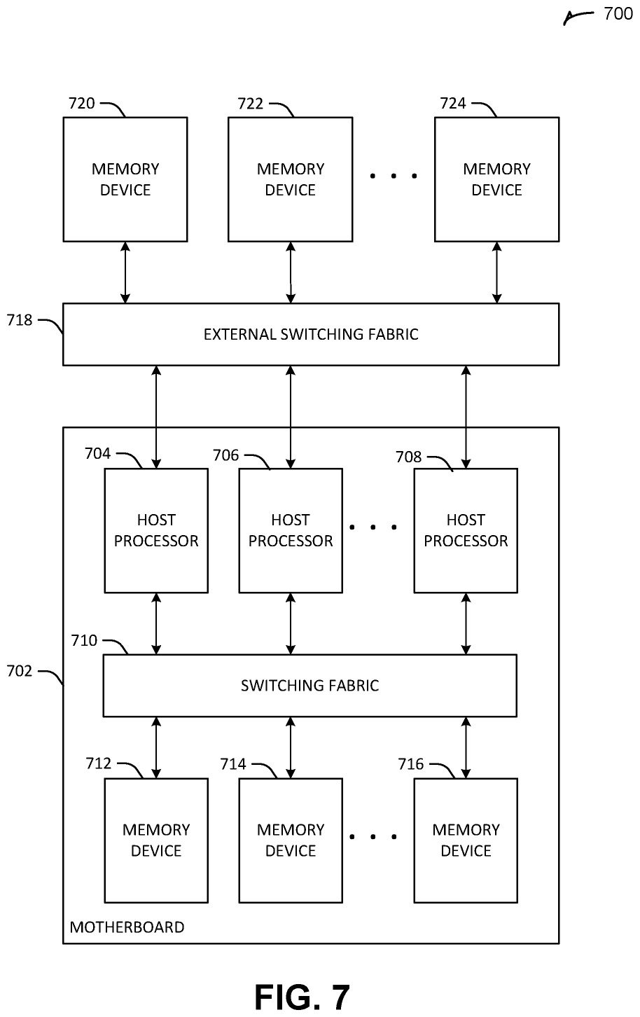

FIG. 7 is a diagram showing an example CNM system 700 that may be used to practice the example systems and methods described herein. The CNM system 700 includes a motherboard 702 comprising host processors 704, 706, 708. In some examples, the motherboard 702 may comprise all or part of a server computing system that may be used for various implementations including, for example, a cloud computing limitation. The host processors 704, 706, 708 may be installed at respective sockets of the motherboard 702. The motherboard 702 may also comprise a switching fabric 710 and memory devices 712, 714, 716. The memory devices 712, 714, 716 may comprise memory controllers including PRNG logic circuits and/or data mover circuits to generate sets of pseudorandom numbers, for example, as described herein.

The switching fabric 710 may operate similarly to the switch circuit 106 to handle communications between the host processors 704, 706, 708 and memory devices 712, 714, 716. In various examples, any of the memory devices 712, 714, 716 may be configured to generate a set of pseudorandom numbers as described herein in response to an indication generated by any of the respective host processors 704, 706, 708.

The CNM system 700 also shows the host processors 704, 706, 708 in communication with external memory devices 720, 722, 724 via an external switching fabric 718. In some examples, the external switching fabric 718 is or includes a chip-to-chip link, such as the AMD Infinity Fabric™ available from Advanced Micro Devices, Inc., of Santa Clara California. The external switching fabric 718 may be in communication with the respective host processors 704, 706, 708 via one or more hardware ports such as, for example, one or more CXL ports, PCIe ports, and/or the like. The external memory devices 720, 722, 724 may also be configured with suitable hardware and/or software to generate pseudorandom numbers as described herein. For example, any of the memory devices 720, 722, 724 may be configured to generate a set of pseudorandom numbers as described herein in response to an indication generated by any of the respective host processors 704, 706, 708.

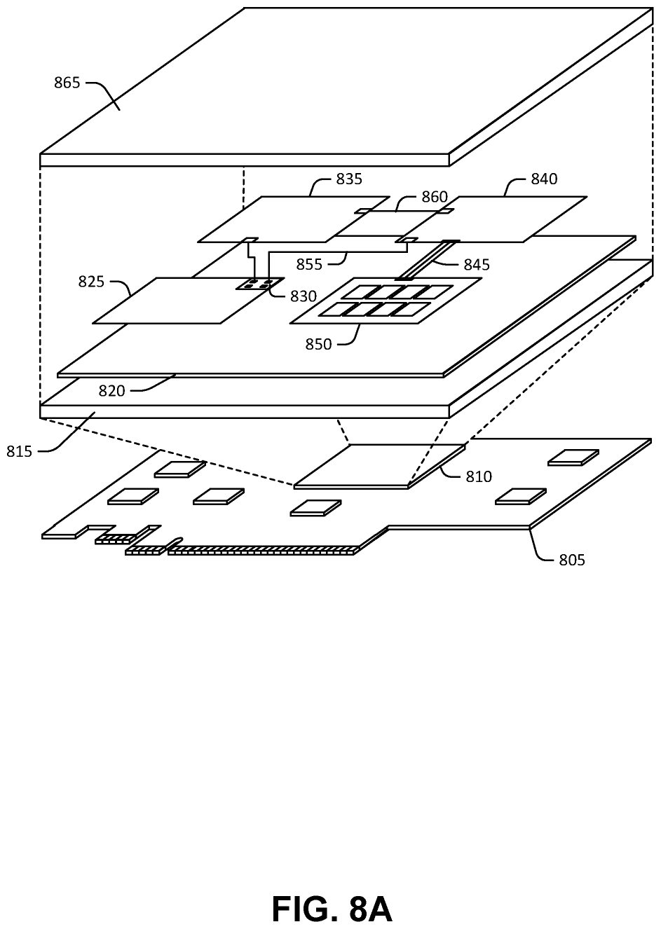

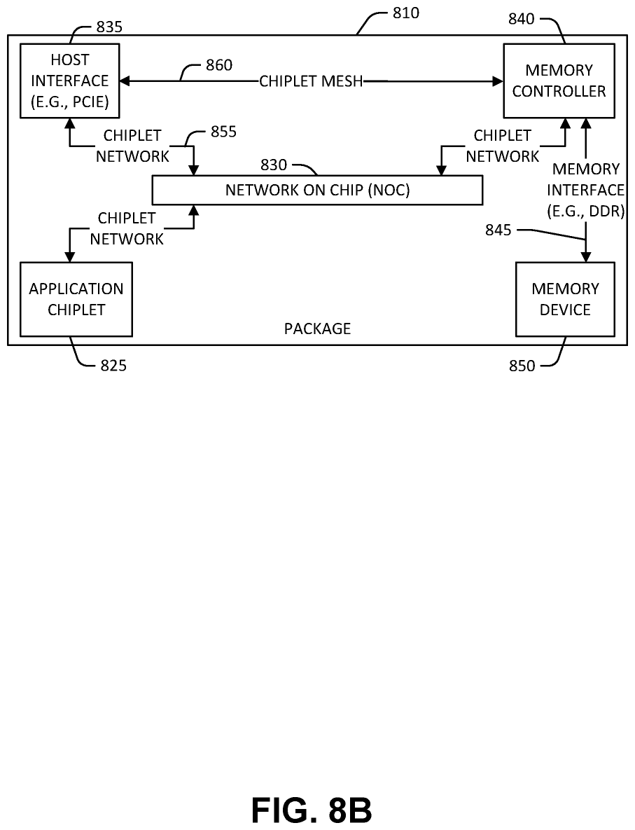

In some examples, the systems and methods described herein to generate sets of pseudorandom numbers may be executed in a chiplet system. FIGS. 8A and 8B illustrate an example of a chiplet system 810, according to an embodiment. FIG. 8A is a representation of the chiplet system 810 mounted on a peripheral board 805 that can be connected to a broader computer system by a peripheral component interconnect express (PCIe), for example. The chiplet system 810 includes a package substrate 815, an interposer 820, and four chiplets: an application chiplet 825, a host interface chiplet 835, a memory controller chiplet 840, and a memory device chiplet 850. Other systems can include many additional chiplets to provide additional functionalities as will be apparent from the following discussion. The package of the chiplet system 810 is illustrated with a lid or cover 865, though other packaging techniques and structures for the chiplet system can be used. FIG. 8B is a block diagram labeling the components in the chiplet system for clarity.

The application chiplet 825 is illustrated as including a network-on-chip (NOC) 830 to support a chiplet network 855 for inter-chiplet communications. In example embodiments NOC 830 can be included on the application chiplet 825. In an example, NOC 830 can be defined in response to selected support chiplets (e.g., chiplets 835, 840, and 850) thus enabling a designer to select an appropriate number or chiplet network connections or switches for the NOC 830. In an example, the NOC 830 can be located on a separate chiplet, or even within the interposer 820. In examples as discussed herein, the NOC 830 implements a chiplet protocol interface (CPI) network.

The CPI is a packet-based network that supports virtual channels to enable a flexible and high-speed interaction between chiplets. CPI enables bridging from intra-chiplet networks to the chiplet network 855. For example the Advanced extensible Interface (AXI) is a widely used specification to design intra-chip communications. AXI specifications, however, cover a great variety of physical design options, such as the number of physical channels, signal timing, power, etc. Within a single chip, these options are generally selected to meet design goals, such as power consumption, speed, etc. However, to achieve the flexibility of the chiplet system, an adapter, such as CPI, is used to interface between the various AXI design options that can be implemented in the various chiplets. By enabling a physical channel to virtual channel mapping and encapsulating time-based signaling with a packetized protocol, CPI bridges intra-chiplet networks across the chiplet network 855.

CPI can use a variety of different physical layers to transmit packets. The physical layer can include simple conductive connections, or can include drivers to increase the voltage, or otherwise facilitate transmitting the signals over longer distances. An example of one such physical layer can include the Advanced Interface Bus (AIB), which, in various examples, can be implemented in the interposer 820. AIB transmits and receives data using source synchronous data transfers with a forwarded clock. Packets are transferred across the AIB at single data rate (SDR) or dual data rate (DDR) with respect to the transmitted clock. Various channel widths are supported by AIB. AIB channel widths are in multiples of 20 bits when operated in SDR mode (20, 40, 60, . . . ), and multiples of 40 bits for DDR mode: (40, 80, 820, . . . ). The AIB channel width includes both transmit and receive signals. The channel can be configured to have a symmetrical number of transmit (TX) and receive (RX) input/outputs (I/Os), or have a non-symmetrical number of transmitters and receivers (e.g., either all transmitters or all receivers). The channel can act as an AIB principal or subordinate depending on which chiplet provides the principal clock. AIB I/O cells support three clocking modes: asynchronous (i.e., non-clocked), SDR and DDR. In various examples, the non-clocked mode is used for clocks and some control signals. The SDR mode can use dedicated SDR-only I/O cells or dual-use SDR/DDR I/O cells.

In an example, CPI packet protocols (e.g., point-to-point or routable) can use symmetrical receive and transmit I/O cells within an AIB channel. The CPI streaming protocol allows more flexible use of the AIB I/O cells. In an example, an AIB channel for streaming mode can configure the I/O cells as all TX, all RX, or half TX and half RX. CPI packet protocols can use an AIB channel in either SDR or DDR operation modes. In an example, the AIB channel is configured in increments of 80 I/O cells (i.e., 40 TX and 40 RX) for SDR mode and 40 I/O cells for DDR mode. The CPI streaming protocol can use an AIB channel in either SDR or DDR operation modes. Here, in an example, the AIB channel is in increments of 40 1/O cells for both SDR and DDR modes. In an example, each AIB channel is assigned a unique interface identifier. The identifier is used during CPI reset and initialization to determine paired AIB channels across adjacent chiplets. In an example, the interface identifier is a 20-bit value comprising a seven-bit chiplet identifier, a seven-bit column identifier, and a six-bit link identifier. The AIB physical layer transmits the interface identifier using an AIB out-of-band shift register. The 20-bit interface identifier is transferred in both directions across an AIB interface using bits 32-51 of the shift registers.

AIB defines a stacked set of AIB channels as an AIB channel column. An AIB channel column has some number of AIB channels, plus an auxiliary channel. The auxiliary channel contains signals used for AIB initialization. All AIB channels (other than the auxiliary channel) within a column are of the same configuration (e.g., all TX, all RX, or half TX and half RX, as well as having the same number of data I/O signals). In an example, AIB channels are numbered in continuous increasing order starting with the AIB channel adjacent to the AUX channel. The AIB channel adjacent to the AUX is defined to be AIB channel zero.

Generally CPI interfaces on individual chiplets can include serialization-deserialization (SERDES) hardware. SERDES interconnects work well for scenarios in which high-speed signaling with low signal count is desirable. SERDES, however, can result in additional power consumption and longer latencies for multiplexing and demultiplexing, error detection or correction (e.g., using block level cyclic redundancy checking (CRC)), link-level retry, or forward error correction. However, when low latency or energy consumption is a primary concern for ultra-short reach, chiplet-to-chiplet interconnects, a parallel interface with clock rates that allow data transfer with minimal latency can be utilized. CPI includes elements to reduce both latency and energy consumption in these ultra-short reach chiplet interconnects.

For flow control, CPI employs a credit-based technique. A recipient, such as the application chiplet 825, provides a sender, such as the memory controller chiplet 840, with credits that represent available buffers. In an example, a CPI recipient includes a buffer for each virtual channel for a given time-unit of transmission. Thus, if the CPI recipient supports five messages in time and a single virtual channel, the recipient has five buffers arranged in five rows (e.g., one row for each unit time). If four virtual channels are supported, then the recipient has twenty buffers arranged in five rows. Each buffer holds the payload of one CPI packet.

When the sender transmits to the recipient, the sender decrements the available credits based on the transmission. Once all credits for the recipient are consumed, the sender stops sending packets to the recipient. This ensures that the recipient always has an available buffer to store the transmission.

As the recipient processes received packets and frees buffers, the recipient communicates the available buffer space back to the sender. This credit return can then be used by the sender to allow transmitting of additional information.

Also illustrated is a chiplet mesh network 860 that uses a direct, chiplet-to-chiplet technique without the need for the NOC 830. The chiplet mesh network 860 can be implemented in CPI, or another chiplet-to-chiplet protocol. The chiplet mesh network 860 generally enables a pipeline of chiplets where one chiplet serves as the interface to the pipeline while other chiplets in the pipeline interface only with themselves.

Additionally, dedicated device interfaces, such as one or more industry standard memory interfaces 845 (such as, for example, synchronous memory interfaces, such as DDR5, DDR6), can also be used to interconnect chiplets. Connection of a chiplet system or individual chiplets to external devices (such as a larger system) can be through a desired interface (for example, a POE interface). Such an external interface can be implemented, in an example, through a host interface chiplet 835, which, in the depicted example, provides a PCIE interface external to chiplet system 810. Such dedicated interfaces 845 are generally employed when a convention or standard in the industry has converged on such an interface. The illustrated example of a Double Data Rate (DDR) interface 845 connecting the memory controller chiplet 840 to a dynamic random access memory (DRAM) memory device chiplet 850 is just such an industry convention.

Of the variety of possible support chiplets, the memory controller chiplet 840 is likely present in the chiplet system 810 due to the near omnipresent use of storage for computer processing as well as sophisticated state-of-the-art for memory devices. Thus, using memory device chiplets 850 and memory controller chiplets 840 produced by others gives chiplet system designers access to robust products by sophisticated producers. Generally, the memory controller chiplet 840 provides a memory device-specific interface to read, write, or erase data. Often, the memory controller chiplet 840 can provide additional features, such as error detection, error correction, maintenance operations, or atomic operator execution. For some types of memory, maintenance operations tend to be specific to the memory device chiplet 850, such as garbage collection in NAND flash or storage class memories, temperature adjustments (e.g., cross temperature management) in NAND flash memories. In an example, the maintenance operations can include logical-to-physical (L2P) mapping or management to provide a level of indirection between the physical and logical representation of data. In other types of memory, for example DRAM, some memory operations, such as refresh, can be controlled by a host processor of a memory controller at some times, and at other times controlled by the DRAM memory device, or by logic associated with one or more DRAM devices, such as an interface chip (in an example, a buffer).

Atomic operators are a data manipulation that, for example, can be performed by the memory controller chiplet 840. In other chiplet systems, the atomic operators can be performed by other chiplets. For example, an atomic operator of “increment” can be specified in a command by the application chiplet 825, the command including a memory address and possibly an increment value. Upon receiving the command, the memory controller chiplet 840 retrieves a number from the specified memory address, increments the number by the amount specified in the command, and stores the result. Upon a successful completion, the memory controller chiplet 840 provides an indication of the command's success to the application chiplet 825. Atomic operators avoid transmitting the data across the chiplet network 860, resulting in lower latency execution of such commands.

Atomic operators can be classified as built-in atomics or programmable (e.g., custom) atomics. Built-in atomics are a finite set of operations that are immutably implemented in hardware. Programmable atomics are small programs that can execute on a programmable atomic unit (PAU) (e.g., a custom atomic unit (CAU)) of the memory controller chiplet 840. FIGS. 8A and 8B illustrate an example of a memory controller chiplet that discusses a PAU.

The memory device chiplet 850 can be, or include any combination of, volatile memory devices or non-volatile memories. Examples of volatile memory devices include, but are not limited to, random access memory (RAM)—such as DRAM) synchronous DRAM (SDRAM), graphics double data rate type 6 SDRAM (GDDR6 SDRAM), among others. Examples of non-volatile memory devices include, but are not limited to, negative-and-(NAND)-type flash memory, storage class memory (e.g., phase-change memory or memristor based technologies), ferroelectric RAM (FeRAM), among others. The illustrated example includes the memory device chiplet 850 as a chiplet; however, the memory device chiplet 850 can reside elsewhere, such as in a different package on the peripheral board 805. For many applications, multiple memory device chiplets can be provided. In an example, these memory device chiplets can each implement one or multiple storage technologies. In an example, a memory chiplet can include multiple stacked memory die of different technologies, for example one or more static random access memory (SRAM) devices stacked or otherwise in communication with one or more dynamic random access memory (DRAM) devices. Memory controller chiplet 840 can also serve to coordinate operations between multiple memory chiplets in chiplet system 810; for example to utilize one or more memory chiplets in one or more levels of cache storage, and to use one or more additional memory chiplets as main memory. Chiplet system 810 can also include multiple memory controller chiplets 840, as can be used to provide memory control functionality for separate processors, sensors, networks, etc. A chiplet architecture, such as chiplet system 810, offers benefits in allowing adaptation to different memory storage technologies and different memory interfaces, through updated chiplet configurations, without requiring redesign of the remainder of the system structure.

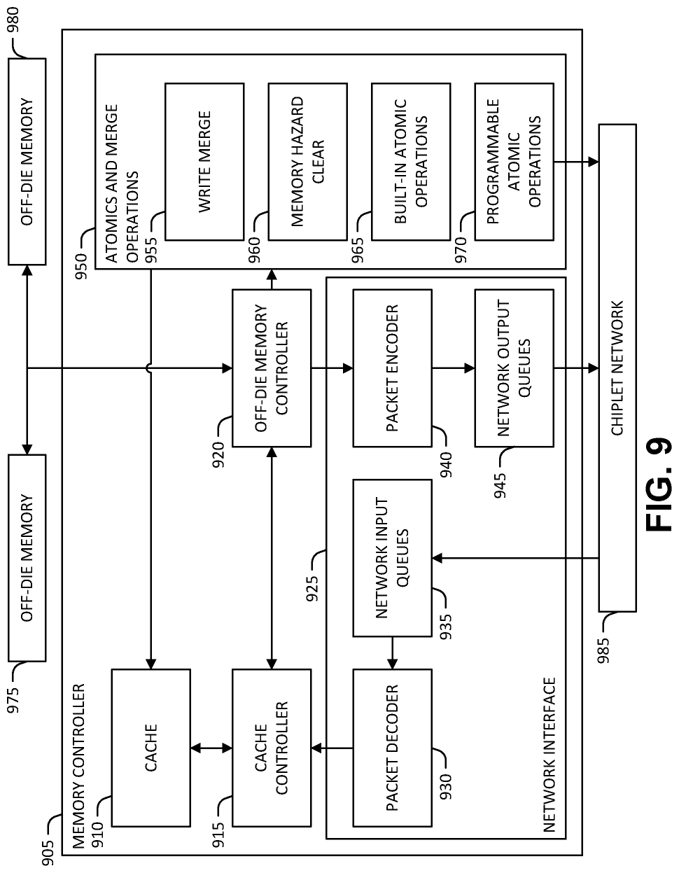

FIG. 9 illustrates components of an example of a memory controller chiplet 905, according to an embodiment. In some examples, the memory controller chip 905 is configured to generate a set of pseudorandom numbers in response to a request from another compute element at the chip system 810. The memory controller chiplet 905 includes a cache 910, a cache controller 915, an off-die memory controller 920 (e.g., to communicate with off-die memory 975), a network communication interface 925 (e.g., to interface with a chiplet network 985 and communicate with other chiplets), and a set of atomic and merge units 950. Members of this set can include, for example, a write merge unit 955, a memory hazard unit 960, built-in atomic unit 965, or a programmable atomic unit (PAU) 970. The various components are illustrated logically, and not as they necessarily would be implemented. For example, the built-in atomic unit 965 likely comprises different devices along a path to the off-die memory. For example, the built-in atomic unit 965 could be in an interface device/buffer on a memory chiplet, as discussed above. In contrast, the programmable atomic unit 970 could be implemented in a separate processor on the memory controller chiplet 905 (but in various examples can be implemented in other locations, for example on a memory chiplet).

The off-die memory controller 920 is directly coupled to the off-die memory 975 (e.g., via a bus or other communication connection) to provide write operations and read operations to and from the one or more off-die memory, such as off-die memory 975 and off-die memory 980. In the depicted example, the off-die memory controller 920 is also coupled for output to the atomic and merge unit 950, and for input to the cache controller 915 (e.g., a memory-side cache controller).

In the example configuration, cache controller 915 is directly coupled to the cache 910, and can be coupled to the network communication interface 925 for input (such as incoming read or write requests), and coupled for output to the off-die memory controller 920.

The network communication interface 925 includes a packet decoder 930, network input queues 935, a packet encoder 940, and network output queues 945 to support a packet-based chiplet network 985, such as CPI. The chiplet network 985 can provide packet routing between and among processors memory controllers, hybrid threading processors, configurable processing circuits, or communication interfaces. In such a packet-based communication system, each packet typically includes destination and source addressing, along with any data payload or instruction. In an example, the chiplet network 985 can be implemented as a collection of crossbar switches having a folded Clos configuration, or a mesh network providing for additional connections, depending upon the configuration.

In various examples, the chiplet network 985 can be part of an asynchronous switching fabric. Here, a data packet can be routed along any of various paths, such that the arrival of any selected data packet at an addressed destination can occur at any of multiple different times, depending upon the routing. Additionally, chiplet network 985 can be implemented at least in part as a synchronous communication network, such as a synchronous mesh communication network. Both configurations of communication networks are contemplated for use for examples in accordance with the present disclosure.

The memory controller chiplet 905 can receive a packet having, for example, a source address, a read request, and a physical address. In response, the off-die memory controller 920 or the cache controller 915 will read the data from the specified physical address (which can be in the off-die memory 975 or in the cache 910), and assemble a response packet to the source address containing the requested data. Similarly, the memory controller chiplet 905 can receive a packet having a source address, a write request, and a physical address. In response, the memory controller chiplet 905 will write the data to the specified physical address (which can be in the cache 910 or in the off-die memories 975 or 980), and assemble a response packet to the source address containing an acknowledgement that the data was stored to a memory.

Thus, the memory controller chiplet 905 can receive read and write requests via the chiplet network 985 and process the requests using the cache controller 915 interfacing with the cache 910 if possible. If the request cannot be handled by the cache controller 915, the off-die memory controller 920 handles the request by communication with the off-die memories 975 or 980, the atomic and merge unit 950, or both. As noted above, one or more levels of cache can also be implemented in off-die memories 975 or 980; and in some such examples can be accessed directly by cache controller 915. Data read by the off-die memory controller 920 can be cached in the cache 910 by the cache controller 915 for later use.

The atomic and merge unit 950 is coupled to receive (as input) the output of the off-die memory controller 920, and to provide output to the cache 910, the network communication interface 925, or directly to the chiplet network 985. The memory hazard unit 960, write merge unit 955 and the built-in (e.g., predetermined) atomic unit 965 can each be implemented as state machines with other combinational logic circuitry (such as adders, shifters, comparators, AND gates, OR gates, XOR gates, or any suitable combination thereof) or other logic circuitry. These components can also include one or more registers or buffers to store operand or other data. The PAU 970 can be implemented as one or more processor cores or control circuitry, and various state machines with other combinational logic circuitry or other logic circuitry, and can also include one or more registers, buffers, or memories to store addresses executable instructions operand and other data, or can be implemented as a processor.

The write merge unit 955 receives read data and request data, and merges the request data and read data to create a single unit having the read data and the source address to be used in the response or return data packet. The write merge unit 955 provides the merged data to the write port of the cache 910 (or, equivalently, to the cache controller 915 to write to the cache 910). Optionally, the write merge unit 955 provides the merged data to the network communication interface 925 to encode and prepare a response or return data packet for transmission on the chiplet network 985.

When the request data is for a built-in atomic operator, the built-in atomic unit 965 receives the request and reads data, either from the write merge unit 955 or directly from the off-die memory controller 920. The atomic operator is performed, and using the write merge unit 955, the resulting data is written to the cache 910, or provided to the network communication interface 925 to encode and prepare a response or return data packet for transmission on the chiplet network 985.

The built-in atomic unit 965 handles predefined atomic operators such as fetch-and-increment or compare-and-swap. In an example, these operations perform a simple read-modify-write operation to a single memory location of 32-bytes or less in size. Atomic memory operations are initiated from a request packet transmitted over the chiplet network 985. The request packet has a physical address, atomic operator type, operand size, and optionally up to 32-bytes of data. The atomic operator performs the read-modify-write to a cache memory line of the cache 910, filling the cache memory if necessary. The atomic operator response can be a simple completion response, or a response with up to 32-bytes of data. Example atomic memory operators include fetch-and-AND, fetch-and-OR, fetch-and-XOR, fetch-and-add, fetch-and-subtract, fetch-and-increment, fetch-and-decrement, fetch-and-minimum, fetch-and-maximum, fetch-and-swap, and compare-and-swap. In various example embodiments 32-bit and 64-bit operations are supported, along with operations on 16 or 32 bytes of data. Methods disclosed herein are also compatible with hardware supporting larger or smaller operations and more or less data.

Built-in atomic operators can also involve requests for a “standard” atomic operator on the requested data, such as comparatively simple, single cycle, integer atomics—such as fetch-and-increment or compare-and-swap—which will occur with the same throughput as a regular memory read or write operation not involving an atomic operator. For these operations, the cache controller 915 can generally reserve a cache line in the cache 910 by setting a hazard bit (in hardware), so that the cache line cannot be read by another process while it is in transition. The data is obtained from either the off-die memory 975 or the cache 910, and is provided to the built-in atomic unit 965 to perform the requested atomic operator. Following the atomic operator, in addition to providing the resulting data to the packet encoder 940 to encode outgoing data packets for transmission on the chiplet network 985, the built-in atomic unit 965 provides the resulting data to the write merge unit 955, which will also write the resulting data to the cache 910. Following the writing of the resulting data to the cache 910, any corresponding hazard bit which was set will be cleared by the memory hazard unit 960.

The PAU 970 enables high performance (high throughput and low latency) for programmable atomic operators (also referred to as “custom atomic transactions” or “custom atomic operators”), comparable to the performance of built-in atomic operators. Rather than executing multiple memory accesses, in response to an atomic operator request designating a programmable atomic operator and a memory address, circuitry in the memory controller chiplet 905 transfers the atomic operator request to PAU 970 and sets a hazard bit stored in a memory hazard register corresponding to the memory address of the memory line used in the atomic operator, to ensure that no other operation (read, write, or atomic) is performed on that memory line, which hazard bit is then cleared upon completion of the atomic operator. Additional, direct data paths provided for the PAU 970 executing the programmable atomic operators allow for additional write operations without any limitations imposed by the bandwidth of the communication networks and without increasing any congestion of the communication networks.

The PAU 970 includes a multi-threaded processor, for example, such as a RISC-V ISA-based multi-threaded processor, having one or more processor cores, and further having an extended instruction set for executing programmable atomic operators. When provided with the extended instruction set for executing programmable atomic operators, the PAU 970 can be embodied as one or more hybrid threading processors. In some example embodiments, the PAU 970 provides barrel-style, round-robin instantaneous thread switching to maintain a high instruction-per-clock rate.

Programmable atomic operators can be performed by the PAU 970 involving requests for a programmable atomic operator on the requested data. A user can prepare programming code to provide such programmable atomic operators. For example, the programmable atomic operators can be comparatively simple, multi-cycle operations such as floating-point addition, or comparatively complex, multi-instruction operations such as a Bloom filter insert. The programmable atomic operators can be the same as or different from the predetermined atomic operators, insofar as they are defined by the user rather than a system vendor. For these operations, the cache controller 915 can reserve a cache line in the cache 910 by setting a hazard bit (in hardware), so that cache line cannot be read by another process while it is in transition. The data is obtained from either the cache 910 or the off-die memories 975 or 980, and is provided to the PAU 970 to perform the requested programmable atomic operator. Following the atomic operator, the PAU 970 will provide the resulting data to the network communication interface 925 to directly encode outgoing data packets having the resulting data for transmission on the chiplet network 985. In addition, the PAU 970 will provide the resulting data to the cache controller 915, which will also write the resulting data to the cache 910. Following the writing of the resulting data to the cache 910, any corresponding hazard bit which was set will be cleared by the cache controller 915.

In selected examples, the approach taken for programmable atomic operators is to provide multiple, generic, custom atomic request types that can be sent through the chiplet network 985 to the memory controller chiplet 905 from an originating source such as a processor or other system component. The cache controllers 915 or off-die memory controller 920 identify the request as a custom atomic and forward the request to the PAU 970. In a representative embodiment, the PAU 970: (1) is a programmable processing element capable of efficiently performing a user defined atomic operator; (2) can perform load and stores to memory, arithmetic and logical operations and control flow decisions; and (3) leverages the RISC-V ISA with a set of new, specialized instructions to facilitate interacting with such controllers 915, 920 to atomically perform the user-defined operation. In desirable examples, the RISC-V ISA contains a full set of instructions that support high level language operators and data types. The PAU 970 can leverage the RISC-V ISA, but will commonly support a more limited set of instructions and limited register file size to reduce the die size of the unit when included within the memory controller chiplet 905.

As mentioned above, prior to the writing of the read data to the cache 910, the set hazard bit for the reserved cache line is to be cleared by the memory hazard unit 960. Accordingly, when the request and read data is received by the write merge unit 955, a reset or clear signal can be transmitted by the memory hazard unit 960 to the cache 910 to reset the set memory hazard bit for the reserved cache line. Also, resetting this hazard bit will also release a pending read or write request involving the designated (or reserved) cache line, providing the pending read or write request to an inbound request multiplexer for selection and processing.

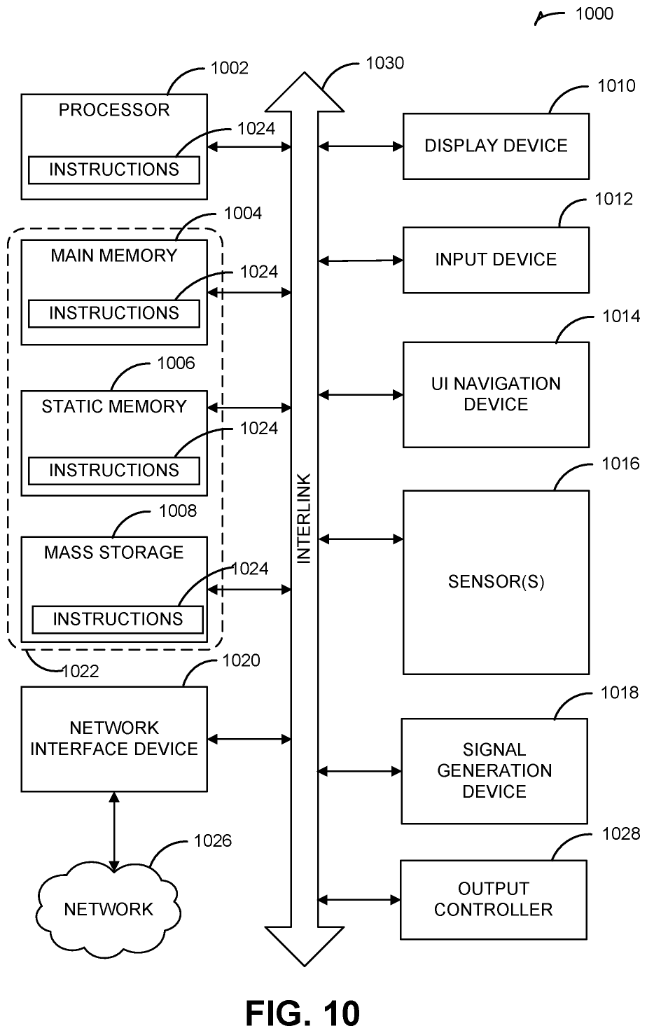

FIG. 10 illustrates a block diagram of an example machine 1000 with which, in which, or by which any one or more of the techniques (e.g., methodologies) discussed herein can be implemented. Examples, as described herein, can include, or can operate by, logic or a number of components, or mechanisms in the machine 1000. Circuitry (e.g., processing circuitry) is a collection of circuits implemented in tangible entities of the machine 1000 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 1000.

In alternative embodiments, the machine 1000 can operate as a standalone device or can be connected (e.g., networked) to other machines. In a networked deployment, the machine 1000 can operate in the capacity of a server machine, a client machine, or both in server-client network environments. In an example, the machine 1000 can act as a peer machine in a peer-to-peer (P2P) (or other distributed) network environment. The machine 1000 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

The machine 1000 (e.g., computer system) can include a hardware processor 1002 (e.g., a central processing unit (CPU), a graphics processing unit (GPU), a hardware processor core, or any combination thereof), a main memory 1004, a static memory 1006 (e.g., memory or storage for firmware, microcode, a basic-input-output (BIOS), unified extensible firmware interface (UEFI), etc.), and mass storage device 1008 (e.g., hard drives, tape drives, flash storage, or other block devices) some or all of which can communicate with each other via an interlink 1030 (e.g., bus). The machine 1000 can further include a display device 1010, an alphanumeric input device 1012 (e.g., a keyboard), and a user interface (UI) navigation device 1014 (e.g., a mouse). In an example, the display device 1010, the input device 1012, and the UI navigation device 1014 can be a touch screen display. The machine 1000 can additionally include a mass storage device 1008 (e.g., a drive unit), a signal generation device 1018 (e.g., a speaker), a network interface device 1020, and one or more sensor(s) 1016, such as a global positioning system (GPS) sensor, compass, accelerometer, or other sensor. The machine 1000 can include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 1002, the main memory 1004, the static memory 1006, or the mass storage device 1008 can be, or include, a machine-readable medium 1022 on which is stored one or more sets of data structures or instructions 1024 (e.g., software) embodying or used by any one or more of the techniques or functions described herein. The instructions 1024 can also reside, completely or at least partially, within any of registers of the hardware processor 1002, the main memory 1004, the static memory 1006, or the mass storage device 1008 during execution thereof by the machine 1000. In an example, one or any combination of the hardware processor 1002, the main memory 1004, the static memory 1006, or the mass storage device 1008 can constitute the machine-readable medium 1022. While the machine-readable medium 1022 is illustrated as a single medium, the term “machine-readable medium” can include a single medium or multiple media (e.g., a centralized or distributed database, or associated caches and servers) configured to store the one or more instructions 1024.

The term “machine readable medium” can include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a set of multiple particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable medium 1022 can be representative of the instructions 1024, such as instructions 1024 themselves or a format from which the instructions 1024 can be derived. This format from which the instructions 1024 can be derived can include source code, encoded instructions (e.g., in compressed or encrypted form), packaged instructions (e.g., split into multiple packages), or the like. The information representative of the instructions 1024 in the machine-readable medium 1022 can be processed by processing circuitry into the instructions to implement any of the operations discussed herein. For example, deriving the instructions 1024 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1024.

In an example, the derivation of the instructions 1024 can include assembly, compilation, or interpretation of the information (e.g., by the processing circuitry) to create the instructions 1024 from some intermediate or preprocessed format provided by the machine-readable medium 1022. The information, when provided in multiple parts, can be combined, unpacked, and modified to create the instructions 1024. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1024 can be further transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1020 can include one or more physical jacks (e.g., Ethernet, coaxial, or phone jacks) or one or more antennas to connect to the network 1026. In an example, the network interface device 1020 can include a set of multiple of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software. A transmission medium is a machine readable medium.

To better illustrate the methods and apparatuses described herein, a non-limiting set of Example embodiments are set forth below as numerically identified Examples.

Example 1 is a computing system comprising: a compute element; and a memory device comprising: a memory array; and a memory controller, the memory controller programmed to perform operations comprising: receiving, from the compute element, an indication to generate a set of pseudorandom numbers; generating the set of pseudorandom numbers; and writing the set of pseudorandom numbers to the memory array for access by the compute element.

In Example 2, the subject matter of Example 1 optionally includes the indication to generate the set of pseudorandom numbers comprising an instruction from the compute element to generate the set of pseudorandom numbers.

In Example 3, the subject matter of Example 2 optionally includes the instruction comprising an indication of at least one address at the memory array to receive the set of pseudorandom numbers.

In Example 4, the subject matter of any one or more of Examples 2-3 optionally includes the instruction from the compute element further comprising an indication of a start address and an offset, the operations further comprising: determining a first address at the memory array, the determining of the first address being based at least in part on the start address; writing a first pseudorandom number of the set of pseudorandom numbers to the memory array at a location indicated by the first address; determining a second address at the memory array, the determining of the second address being based at least in part on the first address and the offset; and writing a second pseudorandom number of the set of pseudorandom numbers to the memory array at a location indicated by the second address.

In Example 5, the subject matter of any one or more of Examples 2-4 optionally includes the instruction from the compute element further comprising a list of address pointers, the operations further comprising: writing a first pseudorandom number of the set of pseudorandom numbers to the memory array at a location indicated by a first address pointer from the list of address pointers; and writing a second pseudorandom number of the set of pseudorandom numbers to the memory array at a location indicated by a second address pointer from the list of address pointers.

In Example 6, the subject matter of any one or more of Examples 2-5 optionally includes the instruction from the compute element further comprising a random seed, the generating of the set of pseudorandom numbers being based at least in part on the random seed.

In Example 7, the subject matter of any one or more of Examples 2-6 optionally includes the instruction comprising a description of a statistical distribution, the operations further comprising conforming the set of pseudorandom numbers to the statistical distribution.

In Example 8, the subject matter of any one or more of Examples 1-7 optionally includes the indication to generate the set of pseudorandom numbers comprising a read request from the compute element, the read request indicating a read from a portion of the memory array.

In Example 9, the subject matter of any one or more of Examples 1-8 optionally includes the operations further comprising at least one of sending a completion message to the compute element or changing a state of a completion flag at a location accessible to the compute element.

Example 10 is a method for generating a set of pseudorandom numbers in a computing system comprising a compute element and a memory device, the method comprising: receiving, by a memory controller of the memory device and from the compute element, an indication to generate a set of pseudorandom numbers; generating, by the memory controller, the set of pseudorandom numbers; and writing, by the memory controller, the set of pseudorandom numbers to a memory array of the memory device for access by the compute element.

In Example 11, the subject matter of Example 10 optionally includes the indication to generate the set of pseudorandom numbers comprising an instruction from the compute element to generate the set of pseudorandom numbers.

In Example 12, the subject matter of Example 11 optionally includes the instruction comprising an indication of at least one address at the memory array to receive the set of pseudorandom numbers.

In Example 13, the subject matter of any one or more of Examples 11-12 optionally includes the instruction from the compute element further comprising an indication of a start address and an offset, the method further comprising: determining a first address at the memory array, the determining of the first address being based at least in part on the start address; writing a first pseudorandom number of the set of pseudorandom numbers to the memory array at a location indicated by the first address; determining a second address at the memory array, the determining of the second address being based at least in part on the first address and the offset; and writing a second pseudorandom number of the set of pseudorandom numbers to the memory array at a location indicated by the second address.

In Example 14, the subject matter of any one or more of Examples 11-13 optionally includes the instruction from the compute element further comprising a list of address pointers, the method further comprising: writing a first pseudorandom number of the set of pseudorandom numbers to the memory array at a location indicated by a first address pointer from the list of address pointers; and writing a second pseudorandom number of the set of pseudorandom numbers to the memory array at a location indicated by a second address pointer from the list of address pointers.

In Example 15, the subject matter of any one or more of Examples 11-14 optionally includes the instruction from the compute element further comprising a random seed, the generating of the set of pseudorandom numbers being based at least in part on the random seed.

In Example 16, the subject matter of any one or more of Examples 11-15 optionally includes the instruction comprising a description of a statistical distribution, the method further comprising conforming the set of pseudorandom numbers to the statistical distribution.

In Example 17, the subject matter of any one or more of Examples 10-16 optionally includes the indication to generate the set of pseudorandom numbers comprising a read request from the compute element, the read request indicating a read from a portion of the memory array.

In Example 18, the subject matter of any one or more of Examples 10-17 optionally includes at least one of sending a completion message to the compute element or changing a state of a completion flag at a location accessible to the compute element.

Example 19 is a non-transitory machine-readable medium comprising instructions thereon that, when executed by a memory controller of a memory device, cause the memory controller to perform operations comprising: receiving, from a compute element, an indication to generate a set of pseudorandom numbers; generating the set of pseudorandom numbers; and writing the set of pseudorandom numbers to a memory array of the memory device for access by the compute element.

In Example 20, the subject matter of Example 19 optionally includes the indication to generate the set of pseudorandom numbers comprising an instruction from the compute element to generate the set of pseudorandom numbers.

The above detailed description includes references to the accompanying drawings, which form a part of the detailed description. The drawings show, by way of illustration, specific embodiments in which they can be practiced. These embodiments are also referred to herein as “examples”. Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the inventive subject matter should be determined with reference to the appended claims, along with the full scope of equivalents to which such claims are entitled.

What is claimed is:

1. A compute near memory system comprising:
a compute element; and
a memory device in communication with the compute elements, the memory device comprising:
a memory array; and
a memory controller, the memory controller programmed to perform operations comprising:
receiving, from the compute element, an indication to generate a set of pseudorandom numbers;
generating the set of pseudorandom numbers; and
writing the set of pseudorandom numbers to the memory array for access by the compute element.

2. The computing system of claim 1, the indication to generate the set of pseudorandom numbers comprising an instruction from the compute element to generate the set of pseudorandom numbers.

3. The computing system of claim 2, the instruction comprising an indication of at least one address at the memory array to receive the set of pseudorandom numbers.

4. The computing system of claim 2, the instruction from the compute element further comprising an indication of a start address and an offset, the operations further comprising:
determining a first address at the memory array, the determining of the first address being based at least in part on the start address;
writing a first pseudorandom number of the set of pseudorandom numbers to the memory array at a location indicated by the first address;
determining a second address at the memory array, the determining of the second address being based at least in part on the first address and the offset; and
writing a second pseudorandom number of the set of pseudorandom numbers to the memory array at a location indicated by the second address.

5. The computing system of claim 2, the instruction from the compute element further comprising a list of address pointers, the operations further comprising:
writing a first pseudorandom number of the set of pseudorandom numbers to the memory array at a location indicated by a first address pointer from the list of address pointers; and
writing a second pseudorandom number of the set of pseudorandom numbers to the memory array at a location indicated by a second address pointer from the list of address pointers.

6. The computing system of claim 2, the instruction from the compute element further comprising a random seed, the generating of the set of pseudorandom numbers being based at least in part on the random seed.

7. The computing system of claim 2, the instruction comprising a description of a statistical distribution, the operations further comprising conforming the set of pseudorandom numbers to the statistical distribution.

8. The computing system of claim 1, the indication to generate the set of pseudorandom numbers comprising a read request from the compute element, the read request indicating a read from a portion of the memory array.

9. The computing system of claim 1, the operations further comprising at least one of sending a completion message to the compute element or changing a state of a completion flag at a location accessible to the compute element.

10. A method for generating a set of pseudorandom numbers in a compute near memory system comprising a compute element and a memory device in communication with the compute element, the method comprising:
receiving, by a memory controller of the memory device and from the compute element, an indication to generate a set of pseudorandom numbers;
generating, by the memory controller, the set of pseudorandom numbers; and
writing, by the memory controller, the set of pseudorandom numbers to a memory array of the memory device for access by the compute element.

11. The method of claim 10, the indication to generate the set of pseudorandom numbers comprising an instruction from the compute element to generate the set of pseudorandom numbers.

12. The method of claim 11, the instruction comprising an indication of at least one address at the memory array to receive the set of pseudorandom numbers.

13. The method of claim 11, the instruction from the compute element further comprising an indication of a start address and an offset, the method further comprising:
determining a first address at the memory array, the determining of the first address being based at least in part on the start address;
writing a first pseudorandom number of the set of pseudorandom numbers to the memory array at a location indicated by the first address;
determining a second address at the memory array, the determining of the second address being based at least in part on the first address and the offset; and
writing a second pseudorandom number of the set of pseudorandom numbers to the memory array at a location indicated by the second address.

14. The method of claim 11, the instruction from the compute element further comprising a list of address pointers, the method further comprising:
writing a first pseudorandom number of the set of pseudorandom numbers to the memory array at a location indicated by a first address pointer from the list of address pointers; and
writing a second pseudorandom number of the set of pseudorandom numbers to the memory array at a location indicated by a second address pointer from the list of address pointers.

15. The method of claim 11, the instruction from the compute element further comprising a random seed, the generating of the set of pseudorandom numbers being based at least in part on the random seed.

16. The method of claim 11, the instruction comprising a description of a statistical distribution, the method further comprising conforming the set of pseudorandom numbers to the statistical distribution.

17. The method of claim 10, the indication to generate the set of pseudorandom numbers comprising a read request from the compute element, the read request indicating a read from a portion of the memory array.

18. The method of claim 10, further comprising at least one of sending a completion message to the compute element or changing a state of a completion flag at a location accessible to the compute element.

19. A non-transitory machine-readable medium comprising instructions thereon that, when executed by a memory controller of a memory device, cause the memory controller to perform operations comprising:
receiving, from a compute element in communication with the memory device, an indication to generate a set of pseudorandom numbers;
generating the set of pseudorandom numbers; and
writing the set of pseudorandom numbers to a memory array of the memory device for access by the compute element.

20. The non-transitory machine-readable medium of claim 19, the indication to generate the set of pseudorandom numbers comprising an instruction from the compute element to generate the set of pseudorandom numbers.
